(19) United States
(12) Patent Application Publication
(10) Pub. No.: US 2008/0035830 A1
(43) Pub. Date: Feb. 14, 2008

(54) Cavity Former

(75) Inventors: James O'Grady, Sunshine (AU); Giuseppe Italiano, Maude (AU); David Andrew Fry, Ashwood (AU); Richard Kenneth Boykett, East Malvern (AU); Paul Darbyshire, Bentleigh (AU); Christopher Thomas Ryan, Brunswick East (AU)

Correspondence Address: HARNESS, DICKEY & PIERCE, P.L.C., P.O. BOX 828, BLOOMFIELD HILLS, MI, 48303, US

(73) Assignee: The Australian Steel Company (Operations) Pty Ltd, Port Melbourne, Victoria (AU)

(21) Appl. No.: 11/596,487

(22) PCT Filed: May 11, 2005
(86) PCT No.: PCT/AU05/00673

§ 371 Date: Nov. 13, 2006

(30) Foreign Application Priority Data
May 11, 2004 (AU) 2004902504
Dec. 22, 2004 (AU) 2004907300

(51) Int. Cl. B28B 7/16

(52) U.S. Cl. 249/13

(57) ABSTRACT

A cavity former (10) for forming one or more cavities in a concrete slab, includes a hollow body about which, during use of the former, poured concrete flows and subsequently cures to form a concrete slab in which the hollow body defines a cavity. A plurality of flanges (20, 21) projects from at least two sides of the body to define floors for respective channels adjacent the sides of the body. A plurality of supports (50, 51, 52 and 53) is integrated with and outstanding from the hollow body and/or flanges to support reinforcement mesh above the body and elongated slab reinforcement in the channels. Respective co-operable formations are disposed on the flanges and respective further sides of the body whereby respective pairs of the cavity formers may be located and relatively positioned together by the formations with one cavity former resting on a flange of the other, whereby to define the channels, which channels receive the poured concrete. Also disclosed is means for defining a seat in the hollow body for an object to project above the hollow body by a height that defines the top of the slab.

### FIELD OF THE INVENTION

This invention relates generally to the formation of concrete slabs and foundations, and more particularly to structures for forming cavities or voids in a slab or foundation.

### BACKGROUND OF THE INVENTION

It is known to use cavity or void formers as space filling elements in the preparation of a concrete slab or foundation, for reducing the volume of concrete required to form the slab or foundation. Such foundations are commonly known as waffle slab foundations. While the reduction of concrete content in a slab as a result of having multiple cavities on its underside serves in turn to reduce the cost of the slab, it also advantageously allows the slab to be built on unstable soil as expanding soils will flow into the formed cavities. Such cavities also facilitate the placement of electrical and plumbing conduits through the slab.

As the cavity formers must be sufficiently strong to support, firstly, the weight of workers when the formers are in place prior to a pour and, secondly, the load of wet concrete when it is poured, the cavity formers are traditionally prefabricated remote from the building site in standard sizes and then delivered to the building site ready to be set in place prior to pouring of the concrete. Known cavity formers include reinforced multiple web-cardboard or fibreboard boxes and so called pods of foamed polymeric material, such as polystyrene.

Cardboard or fibreboard formers must have sufficient structural integrity to support a wet slab for a prescribed period, eg 3 hours, after a concrete pour, before they weaken through moisture absorption. Polystyrene pods overcome this limitation, but have the disadvantage that, when larger pods are cut into smaller shapes for filling cavities of irregular or smaller shape, large quantities of fine polystyrene particles are often generated. Such polystyrene particles present an environmental problem because they are easily scattered by a breeze. Furthermore, polystyrene pods do not disintegrate to more completely form the cavity or void and this presents a disposal and environmental problem when the slab is partially or wholly demolished or reshaped. For these reasons, the use of polystyrene as a cavity former is being restricted in some locations.

Typically, slab formation preparations involve levelling the ground on which the slab is to be formed, erecting shutters to define the perimeter of the slab, locating reinforcement for edge beams of the building to be constructed, laying down building film, i.e. plastics sheets, onto the levelled ground, and then arranging multiple cavity formers in a spaced array on the building film. Bar chairs are then located at spaced intervals in the spaces between the cavity formers, and then reinforcement bars are placed on the bar chairs to form a lattice of reinforcement bar surrounding the cavity formers. Bar chairs are also located on the tops of the cavity formers to support reinforcement mesh that is laid in a blanket covering. After these preparations, the wet concrete is poured about the cavity formers, and cured to form the concrete slab or foundation. A process along these lines is described, for example, in Australian patent 584769 to Koukourou & Partners Pty Ltd.

The process of laying plastic sheets, arranging the cavity formers and bar chairs, and then accurately locating the bar and mesh reinforcement on the bar chairs is time consuming and inconvenient.

Australian petty patents 727681 and 727665 disclose cavity former modules fabricated in recycled plastic. The modules have multiple box elements joined in an integral structure that also defines channels between the box elements. Reinforcing bars are supported in the channels on spaced integral bracket elements that each have an upper edge shaped to center the bar, while reinforcing mesh rests on upstanding ribs formed integrally on the top surfaces of the box elements. Applicant has found that, while cavity former modules of this kind alleviate the environmental concerns of polystyrene pods and address the labour costs of foundation preparation, the modules require a volume of plastic that adversely affects their economics relative to cardboard and polystyrene. They are also bulky to transport.

Reference herein to any specific prior document is not to be taken as an admission or suggestion that the contents of the document constitute common general knowledge, either in Australia or elsewhere.

It is an object of this invention to provide an improved cavity former which embodies a satisfactory compromise between various cost, handling and environmental considerations.

### SUMMARY OF THE INVENTION

In a first aspect, the invention provides a cavity former for forming one or more cavities in a concrete slab, including:
a hollow body about which, during use of the former, poured concrete flows and subsequently cures to form a concrete slab in which the hollow body defines a cavity;
plurality of flanges projecting from at least two sides of the body to define floors for respective channels adjacent said sides of the body;
a plurality of supports integrated with and outstanding from said hollow body and/or flanges to support reinforcement mesh above the body and elongated slab reinforcement in said channels; and
respective co-operable formations on said flanges and respective further sides of said body whereby respective pairs of said cavity formers may be located and relatively positioned together by said formations with one cavity former resting on a flange of the other, whereby to define said channels, which channels receive said poured concrete.

The respective co-operable formations preferable comprise a male formation on said flanges and a female formation projecting from said further sides of the hollow body. Advantageously, said co-operable formations prevent relative movement of adjacent cavity formers coupled by the formations.

In a second aspect, the invention provides a cavity former for forming one or more cavities in a concrete slab, including:
a hollow body about which, during use of the former, poured concrete flows and subsequently cures to form a concrete slab in which the hollow body defines a cavity,
means for defining a seat in said hollow body for an object to project above said hollow body by a height that defines the top of said slab.

Such an object may be termed a slab level indicator.

In its second aspect, the invention also extends to a cavity former according to the second aspect of the invention in combination with an object in said seat, projecting above said hollow body by a height that defines the top of said slab.

The invention also embraces, in its second aspect, a kit of multiple said cavity formers and said slab level indicators.

The invention further provides, in a third aspect, a cavity former for forming one or more cavities in a concrete slab, including:
a hollow body about which, during use of the former, poured concrete flows and subsequently cures to form a concrete slab in which the hollow body defines a cavity;
first and second support elements projecting from opposite sides of said hollow body and arranged so that when two of the hollow body are appropriately positioned adjacent each other, said first support elements on one body and said second support elements on the other body are offset but co-operable to mutually support a reinforcement bar between said bodies, said support elements being configured to center said reinforcement bar between said bodies.

In an embodiment of the first and third aspects of the invention, one of the co-operable formations may also serve as said first or second support elements.

The hollow body may be a rectangular pod open on a lowermost side.

The hollow body preferably has a first wall, and a depending skirt wall about the periphery of the first wall. The hollow body may further have structure defining, within said periphery, at least one depending hollow pillar formation for in situ bracing said first wall to an underlying surface on which said skirt wall also rests.

In an embodiment of the first and second aspects of the invention, the abovementioned seat for the object comprises an opening at the first wall of the interior of the hollow tubular structure.

### BRIEF DESCRIPTION OF THE DRAWINGS

The invention will now be further described, by way of example only, with reference to the accompanying drawings, in which:

FIG. 1 is a perspective view from above of a single-pod cavity former according to an embodiment of the invention;

FIG. 2 is a plan view of the cavity former depicted in FIG. 1;

FIG. 3 is an underneath perspective view of the cavity former depicted in FIG. 1;

FIG. 4 is a perspective view of a slab level indicator for use in the third aspect of the invention;

FIG. 5 is a side elevational view of the slab level indicator;

FIG. 6 depicts part of an array of coupled cavity formers in situ on a prepared ground surface, laid up with reinforcement bar and mesh, and ready to receive wet concrete to form a waffle slab formation; and

FIG. 7 is a fragmentary cross-section of the cured slab.

### DETAILED DESCRIPTION OF EMBODIMENTS OF THE INVENTION

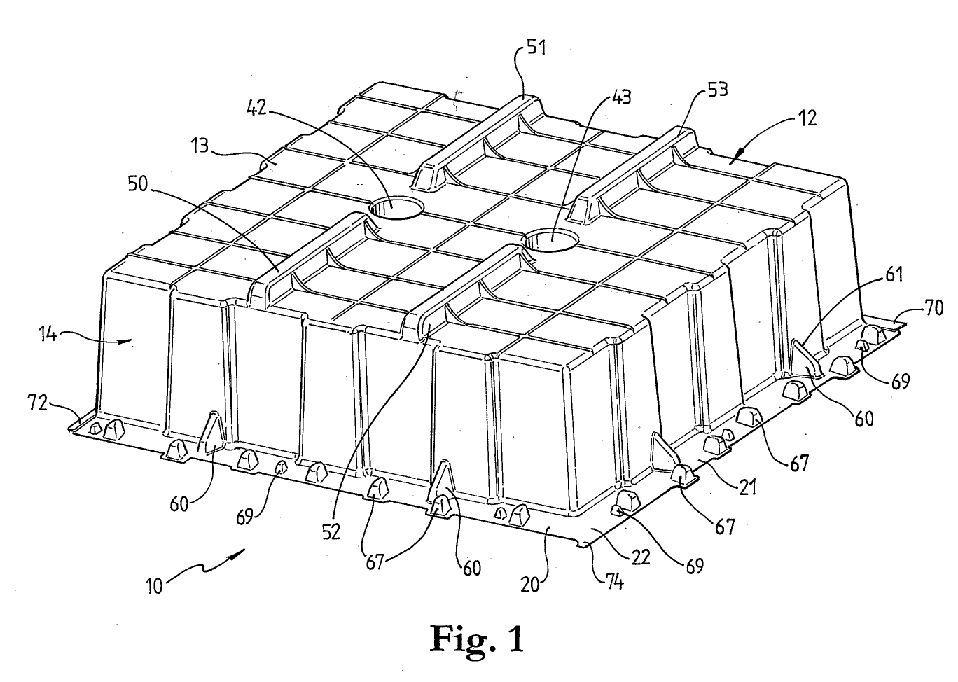

The cavity former 10 illustrated in FIGS. 1 to 3 is of a single pod configuration, including a first or top wall 12, which in situ is horizontal, and a peripheral skirt wall 14 depending from and extending about the peripheral edge of top wall 12. The pod is generally hollow within walls 12, 14 and the peripheral edge of wall 12 is generally square in plan. Cavity former 10 is moulded in a suitable polymer or polymeric plastics material and is advantageously moulded in a recycled plastics material. An appropriate material is polypropylene, virgin or recycled. Other possible alternates includes polyethylene, cross-linked polyethylene and PET. The material is preferably selected to provide an effective moisture barrier, as well as the necessary structural properties.

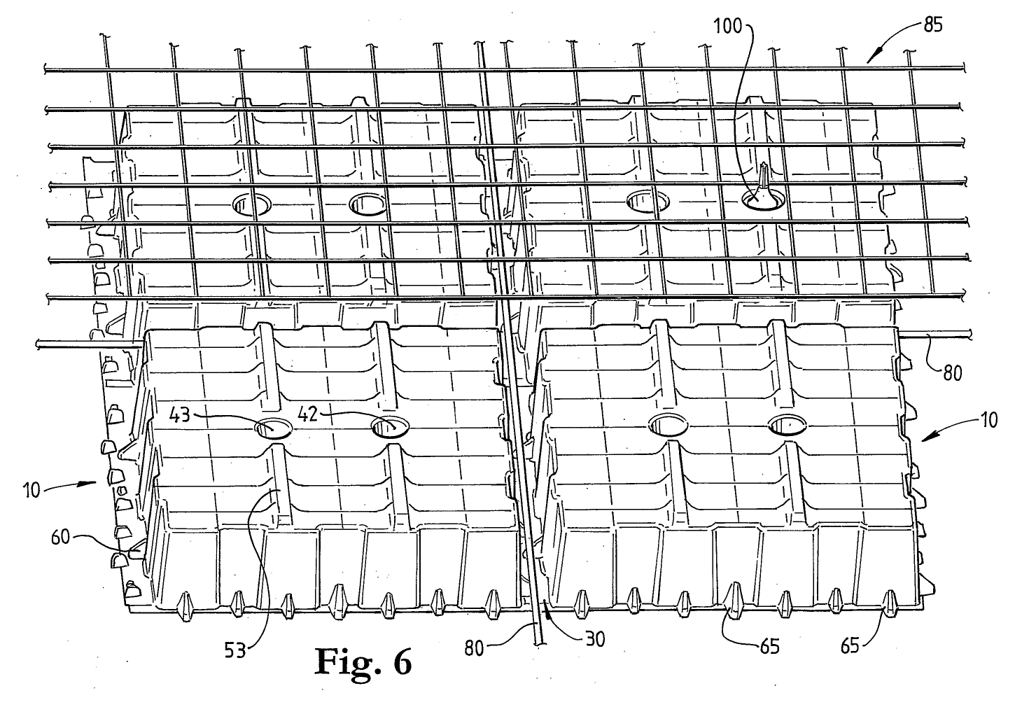

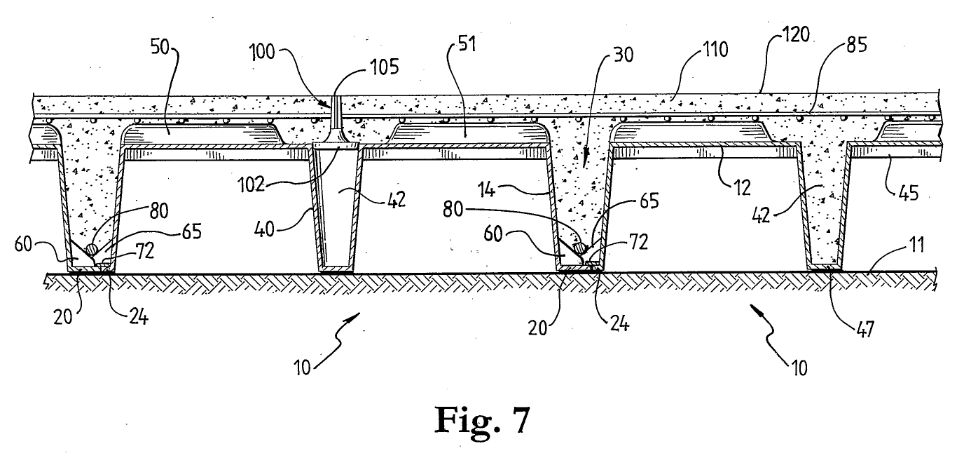

Extending from the bottom edge of skirt wall 14 at two adjacent sides of the pod are respective flanges 20, 21 that merge at corner 22. When multiple cavity formers are arranged in an array on a ground surface, these flanges 20, 21 rest on the ground surface and extend under the bottom edge 23, 24 of the skirt wall 14 of respective other cavity formers at one of their sides not containing a projecting flange or (as illustrated) only containing a small lip 23a, 24a. A pair of adjacent cavity formers arranged in this way is illustrated in FIGS. 6 and 7, from which it will be seen that the flange and adjacent skirt walls define a channel 30.

It will be appreciated that other flange arrangements are possible. For example, all four sides may have a flange, either of similar width or of varying width. In a particular form of the latter arrangement, two adjacent sides may have a relatively much wider flange (eg. 110 mm) while the other sides have a much narrower flange (eg. 20 mm)

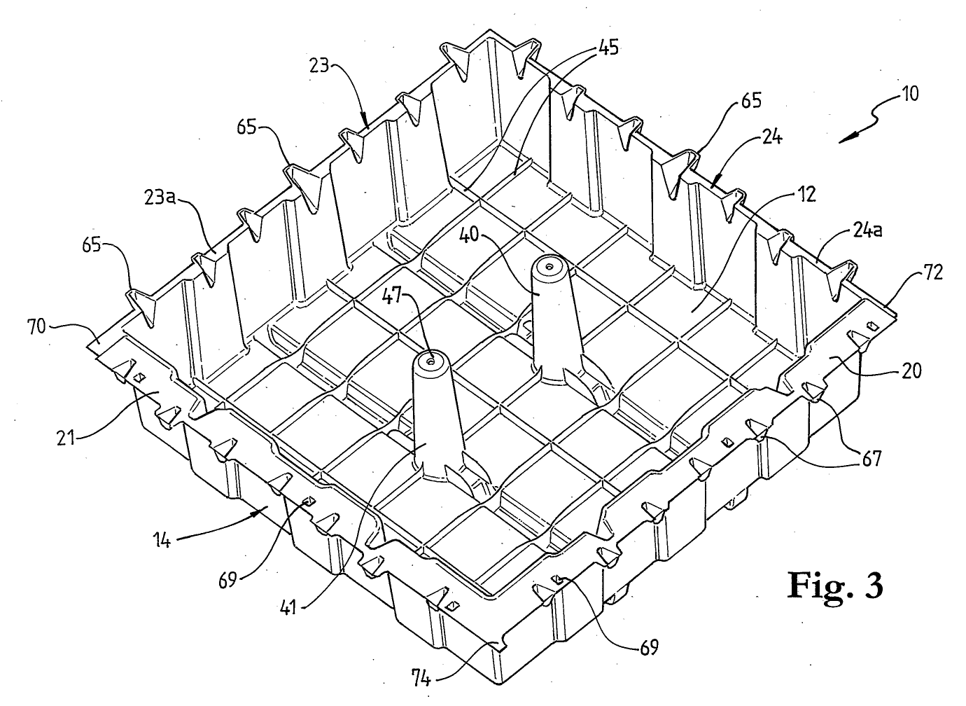

Cavity former 10 is reinforced in a number of ways, so that it is able to support the weight of concrete, or, prior to pouring of the concrete, the weight of personnel walking across the pod. Firstly, two hollow, tapered tubular pillars 40, 41 (FIG. 3) depend from respective positions on a transverse centre line of pod 10, with their axes equidistant from each other and from the adjacent edges of top wall 12. The hollow interiors 42, 43 of these pillars are open at top wall 12: their lowermost tips 47 are flush with the bottom edge of skirt wall 14 and thereby the two pillars serve to brace top wall 12 to an underlying ground surface 11 (FIG. 7). As viewed on the upper surface 13 of top wall 12, the hollow interiors 42, 43 of pillars 40, 41 appear as open wells.

A second element of reinforcement of cavity former 10 is provided by moulding skirt wall 14 and flanges 20, 21 with a broad-ribbed structure. In a similar fashion, the underside of the pod has shallow ribbing or gusseting 45 to provide additional rigidity.

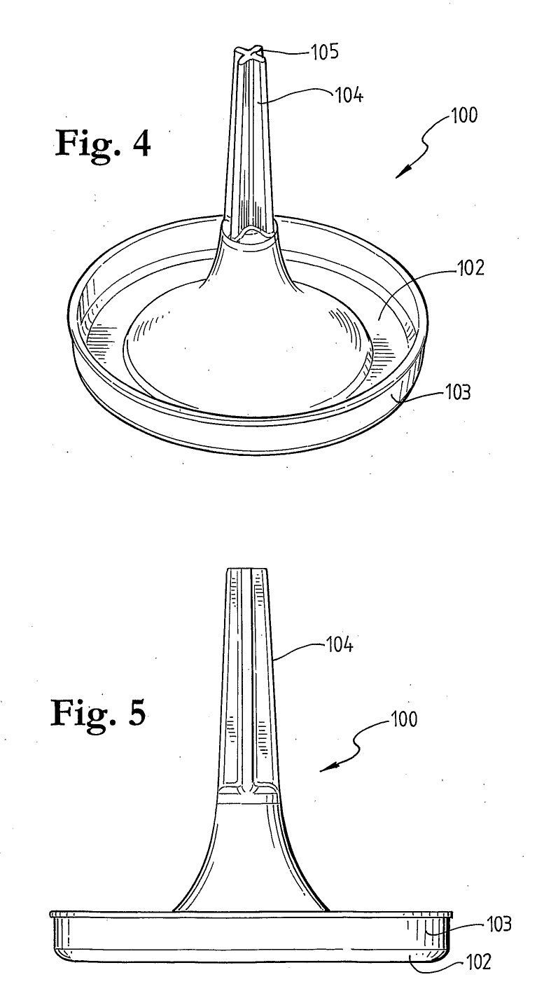

The wells 42, 43 formed by hollow pillars 40, 41 serve as seats for slab level indicator devices 100, eg. of the form illustrated in FIGS. 4 and 5. Each indicator 100 is a small injection-moulded dished element with a slightly tapered cylindrical flanged base 102. Base 102 is dimensioned to make a firm close-fitting engagement with each well 42, 43, so that a lip 105 at the edge of upstanding flange 103 of the base rests on the rim of the well. Concentric with base 102 is an upstanding concavely conical body 104 of upper cruciform cross-section that extends to a flat tip 105 at the exact required height of a slab to be formed over the pod.

It will appreciated that there are other ways in which a slab level indicator device can be mounted on a cavity former 10. For example, the top wall 12 may have an integrally formed closed recess to seat the indicator device, or a frangible section for receiving the indicator device in a close enough fit that wet cement will not substantially protrude to the interior of the pod. Moreover, the illustrated slab level indicator 100 is only one of many varieties of form that the indicator could take: it may for example be a simple cut length of conduit or rod.

The cavity former is fashioned with two kinds of support elements for supporting slab reinforcing products. Firstly, on the upper surface 13 of top wall 12 are two pairs 50, 51; 52, 53 of upstanding hollow ribs, which are respectively aligned with the axes of wells 42, 43 but with their inner ends set well back from the wells. These ribs 50, 51; 52, 53 support reinforcement mesh at a level spaced above upper surface 13 of the pod.

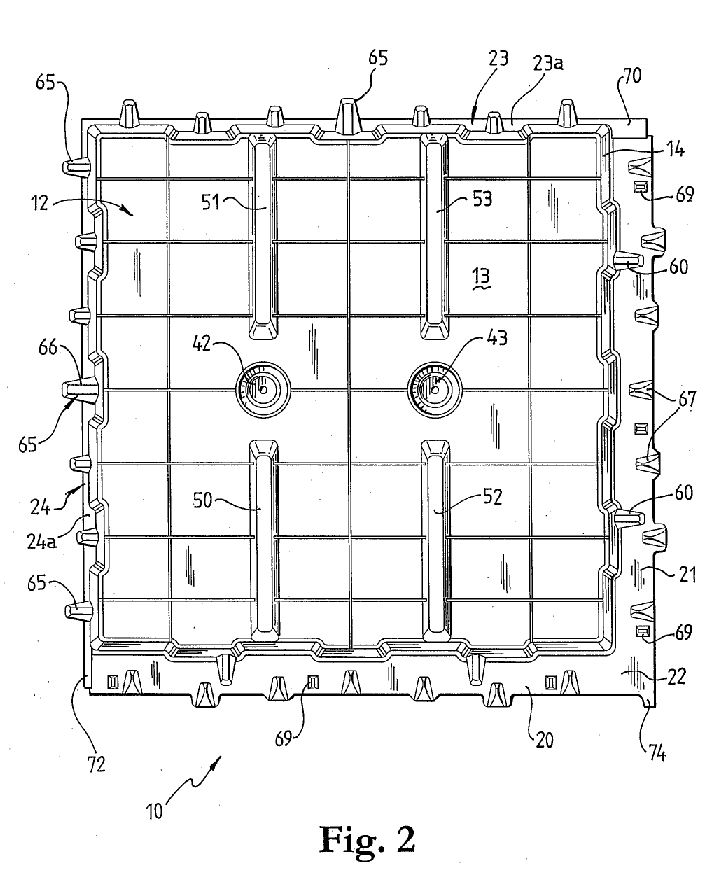

The other reinforcement support elements comprise cooperating projections 60, 65 that respectively form gusset like members at the junction of skirt wall 14 and flanges 20, 21, and project from the lower end of skirt wall 14 on the sides 23, 24 of the pod remote from flanges 20, 21. These projections 60, 65 each have an outwardly and downwardly tapered surface 61, 66 and, as best appreciated from FIG. 2, are relatively offset so that when two pods are placed side by side in the manner earlier described to form a channel 30, projections 60, 65 cooperate as spaced supports for a reinforcing bar 80 dropped into the channel. Moreover, their outwardly tapered surfaces also cooperate to provide automatic centering of the bar 80 in the channel.

As well as serving as support elements for reinforcing bar, projections 65 serve a second purpose. They are hollow female or socket-like elements for multiple close-fitting complementary male elements or studs 67, of generally triangular profile, on the top surfaces of flanges 20, 21. The engagement of hollow female projections 65 with upstanding studs 67 provides an accurate relative location of adjacent pods and also prevents their relative displacement either when personnel walk on the pods or when wet cement is poured onto an array of the pods. Outward splaying of skirt wall 14 at pod sides 23, 24, where the skirt wall is not stablised by a substantial flange, is substantially prevented or limited by small secondary projections 69 spaced along flanges 20, 21.

It will have been noted that the illustrated cavity former 10 has a number of features that permit the cavity former to be snugly nested with a like cavity former whereby multiple cavity formers may be stacked for storage and delivery. The particular features that permit nesting include the slightly flared form of skirt wall 14, the slight trapezoidal shape of the ridges and channels along skirt wall 14, the tapered form of pillars 40, 41 (which permits the pillars of an overlying cavity former to be received within the wells 42, 43 of the underlying cavity former), and the hollow form of ribs 50-53.

When it is required to form a waffle slab foundation at a building site, the necessary number of cavity formers or pods 10 is delivered to the site in multiple nested stacks. At the site, the ground 11 on which the slab is to be formed is levelled and prepared, shutters are erected to define the perimeter of the slab, and reinforcement elements are positioned for edge beams of the building to be constructed. Typically one or two workers then place individual cavity formers 10 in an array on the levelled ground such that they are located and interlocked by engagement of female or socket projections 65 on upstanding studs 67, and so a square array is formed (FIG. 7) containing a grid of orthogonally intersecting channels 30. Because the non-flanged lower edges 23, 24 of each cavity former 10 are seated firmly on respective flanges 20, 21 of adjacent cavity formers, there is no need to have previously laid plastic sheeting on the levelled ground, as is the conventional practice when forming waffle pod foundations.

At the corner intersections where flanges 20, 21 might have a 2- or 4-layer overlap, the consequent uplifting of the corners is prevented or minimised by complementary corner rebates 70, out-of-plane steps 72, and projecting tabs 74 at the respective outer corners where flanges 20, 21 meet or end.

With continuing reference to FIG. 7 in particular, elongate reinforcement bars 80 are then dropped into each channel 30 and immediately centered and supported by projections 60, 65. If desired, by varying slightly the size and height of projections 60, 65 according to the side of the cavity former, it can be arranged that the reinforcement bars 80 dropped in one orientation rest at a lower position and those dropped at the other orientation will rest at a higher position, thereby avoiding interference at their points of overlap (provided of course the bars are dropped in the correct order).

A few level indicators 100 are positioned in wells 42, 43 at appropriate intervals (2 metre spacing is thought to be sufficient). The final act of preparation is to drop reinforcing mesh 85 onto the support ribs 50-53 of the whole array so that indicators 100 all project above the mesh.

Where reduced size pods are required, for example where a final row is of lesser width than the standard pod, the expected practice is to cut a pod along two intermediate planes, remove the intervening segment, and then re-unite the outer segments, if necessary with adhesive or the like, and position them appropriately. This approach ensures pods of reduced size that are substantially still enclosed.

Wet cement is then poured onto the array so that it flows over and about pods 10, filling channels 30 and enveloping the reinforcing bars 80 and mesh 85. During this step, the inter-engagement of projections 65, 67 prevents displacement of the individual cavity formers, and the underlap of non-flanged wall edges 23, 24 by flanges 20, 21 prevents escape of wet cement under the pods. The wet cement is then screed off to the level 120 determined by the tips 105 of level indicators 100 and the task is complete save for allowing sufficient time for the cement to cure and the slab 110 to be formed.

It will be appreciated that the illustrated cavity formers 10 combine a number of valuable features. By virtue of reinforcing pillars 40, 41, the ribbed structure of skirt wall 14 and flanges 20, 21, and ribbing 45, the wall thickness of the moulding can be kept to a minimum, for example 1.5 mm but 1 mm or less may be possible, and thereby material usage minimised. The underlap of the flanges 20, 21 with the un-flanged edges 23, 24 of adjacent cavity formers eliminates the step of placing plastic sheeting. The integral supports for reinforcement bar and mesh avoids any need to place bar chairs, and the offset supports in channels 30 optimise the support and centering of the reinforcement bars. Cooperating sockets 65 and studs 67 provide accurate location and prevent separation. Projections 69 support the un-flanged walls against outward splaying. Pillars 40, 41 provide a simple means of locating level indicators which themselves readily facilitate correct and accurate formation of the slab in accordance with specifications.

1. A cavity former for forming one or more cavities in a concrete slab, including:
a hollow body about which, during use of the former, poured concrete flows and subsequently cures to form a concrete slab in which the hollow body defines a cavity;
a plurality of flanges projecting from at least two sides of the body to define floors for respective channels adjacent said sides of the body;
a plurality of supports integrated with and outstanding from said hollow body and/or flanges to support reinforcement mesh above the body and elongated slab reinforcement in said channels; and
respective co-operable formations on said flanges and respective further sides of said body whereby respective pairs of said cavity formers may be located and relatively positioned together by said formations with one cavity former resting on a flange of the other, whereby to define said channels, which channels receive said poured concrete.

2. A cavity former according to claim 1, wherein the respective co-operable formations comprise a male formation on said flanges and a female formation projecting from said further sides of the hollow body.

3. A cavity former according to claim 1, wherein said co-operable formations prevent relative movement of adjacent cavity formers coupled by the formations.

4. A cavity former according to claim 1, wherein said hollow body is a rectangular pod open on a lowermost side.

5. A cavity former according to claim 4, wherein said hollow body has a first wall, and a depending skirt wall about the periphery of the first wall.

6. A cavity former according to claim 5, wherein said hollow body further has structure defining, within said periphery, at least one depending hollow pillar formation for in situ bracing said first wall to an underlying surface on which said skirt wall also rests.

7. A cavity former according to claim 6, wherein said structure comprises a hollow tubular structure which constitutes said pillar formation.

8. A cavity former according to claim 7, wherein said hollow tubular structure has its interior open at said first wall.

9. A cavity former according to claim 5, wherein said hollow body further has a pair of upstanding ribs formed integrally on the outer surface of said first wall for supporting reinforcing mesh above said hollow body.

10. A cavity former according to claim 1, wherein said hollow body is configured to allow nesting of said cavity former with a second similar cavity former, thereby to allow stacking of a multiplicity of said cavity formers.

11. A cavity former for forming one or more cavities in a concrete slab, including:
a hollow body about which, during use of the former, poured concrete flows and subsequently cures to form a concrete slab in which the hollow body defines a cavity; and
means for defining a seat in said hollow body for an object to project above said hollow body by a height that defines the top of said slab.

12. A cavity former according to claim 11, wherein said hollow body is a rectangular pod open on a lowermost side.

13. A cavity former according to claim 12, wherein said hollow body has a first wall, and a depending skirt wall about the periphery of the first wall.

14. A cavity former according to claim 13, wherein said hollow body further has structure defining, within said periphery, at least one depending hollow pillar formation for in situ bracing said first wall to an underlying surface on which said skirt wall also rests.

15. A cavity former according to claim 14, wherein said structure comprises a hollow tubular structure which constitutes said pillar formation.

16. A cavity former according to claim 15, wherein said seat for said object comprises the opening at said first wall of the interior of said hollow tubular structure.

17. A cavity former according to claim 13, wherein said seat is in said first wall.

18. A cavity former according to claim 13, wherein said hollow body further has a pair of upstanding ribs formed integrally on the outer surface of said first wall for supporting reinforcing mesh above said hollow body.

19. A cavity former according to claim 11, wherein said hollow body is configured to allow nesting of said cavity former with a second similar cavity former, thereby to allow stacking of a multiplicity of said cavity formers.

20. A cavity former according to claim 11 in combination with an object in said seat, projecting above said hollow body by a height that defines the top of said slab.

21. A kit of multiple cavity formers according to claim 11, and multiple objects for engaging said seats to project above said hollow body by a height that defines the top of said slab.

22. A cavity former for forming one or more cavities in a concrete slab, including:
a hollow body about which, during use of the former, poured concrete flows and subsequently cures to form a concrete slab in which the hollow body defines a cavity;
first and second support elements projecting from opposite sides of said hollow body and arranged so that when two of the hollow body are appropriately positioned adjacent each other, said first support elements on one body and said second support elements on the other body are offset but co-operable to mutually support a reinforcement bar between said bodies, said support elements being configured to center said reinforcement bar between said bodies.

23. A cavity former according to claim 22, further including:
a plurality of flanges projecting from at least two sides of the body to define floors for respective channels adjacent said sides of the body;
a plurality of supports integrated with and outstanding from said hollow body and/or flanges to support reinforcement mesh above the body and elongated slab reinforcement in said channels; and
respective co-operable formations on said flanges and respective further sides of said body whereby respective pairs of said cavity formers may be located and relatively positioned together by said formations with one cavity former resting on a flange of the other, whereby to define said channels, which channels receive said poured concrete;
wherein one of said co-operable formations also serves as said first or second support element.

24. A cavity former according to claim 23, wherein the respective co-operable formations comprise a male formation on said flanges and a female formation projecting from said further sides of the hollow body.

25. A cavity former according to claim 2 wherein said co-operable formations prevent relative movement of adjacent cavity formers coupled by the formations.

26. A cavity former according to claim 22, wherein said hollow body is a rectangular pod open on a lowermost side.

27. A cavity former according to claim 26, wherein said hollow body has a first wall, and a depending skirt wall about the periphery of the first wall.

28. A cavity former according to claim 27, wherein said hollow body further has structure defining, within said periphery, at least one depending hollow pillar formation for in situ bracing said first wall to an underlying surface on which said skirt wall also rests.

29. A cavity former according to claim 28, wherein said structure comprises a hollow tubular structure which constitutes said pillar formation.

30. A cavity former according to claim 29, wherein said hollow tubular structure has its interior open at said first wall.

31. A cavity former according to claim 27, wherein said hollow body further has a pair of upstanding ribs formed integrally on the outer surface of said first wall for supporting reinforcing mesh above said hollow body.

32. A cavity former according to claim 22, wherein said hollow body is configured to allow nesting of said cavity former with a second similar cavity former, thereby to allow stacking of a multiplicity of said cavity formers.
